(19) United States
(12) Patent Application Publication
(10) Pub. No.: US 2003/0228801 A1
(43) Pub. Date: Dec. 11, 2003

(54) Low profile lamp socket

(76) Inventor: Walter Holzer, Meersburg (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/397,089

(22) Filed: Mar. 26, 2003

Related U.S. Application Data
(63) Continuation-in-part of application No. 09/633,237, filed on Aug. 4, 2000, now abandoned.
Application No. 09/633,237 is a continuation of application No. PCT/EP99/00836, filed on Feb. 9, 1999.

(30) Foreign Application Priority Data
Feb. 10, 1998 (DE) 198 05 258.8
Aug. 19, 1999 (WO) WO 99/41811

(51) Int. Cl. H01R 13/648

(52) U.S. Cl. 439/608

(57) ABSTRACT

A low-profile lamp socket which can be used for conventional incandescent lamps, but which is especially adapted for energy-saving lamps which have an integrated ballast. The socket has a central housing with electrical contacts, surrounded by a protective collar. The electrical contacts are interconnected to clamps which are arranged annularly around the contacts, outside of the protective collar. The resultant structure is shorter than conventional sockets and is also safer in that the risk of electrical shock during bulb insertion and removal is lessened.

### RELATED APPLICATIONS

This application is a continuation-in-part of application Ser. No. 09/633,237, filed Aug. 4, 2000, which was a continuation of International Application Serial No. PCT/EP99/00836, filed on Feb. 9, 1999, and published on Aug. 19, 1999 as International Publication No. WO 99/41811, and claims priority from German Patent Application Serial No. 198 05 258.8, filed Feb. 10, 1998.

### FIELD OF THE INVENTION

There are four basic types of artificial lighting in general use today: incandescent, fluorescent, high-intensity discharge, and low-pressure sodium. For more than a century, incandescent lamps (“light bulbs” in the United States) have dominated the residential lighting market, despite the fact that such lamps are the most expensive to operate because much of the electrical energy supplied to incandescent lamps is dissipated as heat, not light. These high temperatures also explain why such lamps are fairly short-lived. On the other hand, incandescent lamps are relatively inexpensive, apart from the cost of labor to replace burned-out lamps. Most importantly, because this type of lighting has been in vogue for such a long period of time, lamp receptacles (sockets), and other lamp hardware has been constructed with the size and shape of the typical incandescent lamp in mind, which also contributes to the reluctance to change to a more energy-efficient alternative.

As technology has evolved, ecological concerns have come into play, and the cost of energy and labor has increased, the total dominance of incandescent lighting has started to slip with the advent of so-called “energy-efficient” lamps—typically, compact fluorescent lamps. Compact fluorescent lamps can replace incandescent lamps which are roughly 3 to 4 times their wattage with no loss in level of illumination, thus resulting in immediate energy savings. Although a compact fluorescent lamp is considerably more costly than its incandescent counterpart (10 to 20 times), such a lamp will have a life which is 10 to 15 times as long. Thus, economic considerations weigh heavily in favor of these new lamps, at least in indoor applications.

Compact fluorescent lamps are most often manufactured with threaded Edison bases which are compatible with threaded Edison sockets which have been widely used to both mount and supply power to incandescent lamps. This permits compact fluorescent lamps to be marketed as direct replacements for incandescent lamps.

One problem with the direct interchangeability of compact fluorescent lamps with their incandescent counterparts is size. By their very nature, fluorescent lamps require electronic ballasts for starting and circuit protection. Ideally, the ballast would be a separate unit, apart from the lamp itself; i.e., the ballast would be part of the socket assembly. However, the more common practice is to incorporate the electronic ballast as part of the lamp, requiring a user to simply remove the incandescent bulb and replace it with a compact fluorescent lamp. Unfortunately, the presence of the built-in electronic ballast results in a lamp structure that is somewhat larger than its incandescent counterpart.

Another problem with the Edison base and socket system is in the area of safety. Despite the recognition that these systems pose a shock hazard to the user, Edison base and socket systems have been retained, even in modern energy-saving lamps, in order to make them easily exchangeable with long-standing incandescent lamps. Although base and socket systems have been proposed for eliminating this shock hazard (see applicant's U.S. Pat. No. 6,113,416), a switch to a totally new base and socket system requires enormous costs in retrofitting existing wiring. Thus, the conventional Edison system—exemplified, for example, by U.S. Pat. Nos. 1,054,419 and 1,519,923, the latter of which has a contact system disposed centrally in the base housing and noncontact-shock-proof contacts arranged around a protective collar—continues to be widely used.

### SUMMARY OF THE INVENTION

The task of the present invention is to further improve new, contact-shock-proof sockets, especially with reference to size and user friendliness. A major objective is shortening of the new socket, in comparison with the previous ones, in order to at least partially compensate for the greater length of newly-developed energy-saving lamps in comparison with incandescent lamps. A second objective is to provide a socket which reduces the risk of electrical shock.

This is achieved according to the invention in that the electrical connectors are arranged in annular fashion outside of a protective collar, which protects a user against contact with the lamp contacts during insertion of the lamp into the socket. This annular arrangement is particularly advantageous, and for contact-shock-proof sockets of the type shown in the above-referenced U.S. Pat. No. 6,113,416.

The possibility of introducing the power lines axially favors incorporation of these improved sockets in lighting fixtures having an electrical contact system comprising four pins on the base of the lamp or lamp ballast.

Another improvement consists of the fact that a baseplate is present that serves for fastening of the socket to a flat surface, for example to a wall. This baseplate is provided with a central entry for the power lines, and channels or cavities to accommodate the wires, which results in the connectors being arranged in an annular fashion.

An entry can expediently be provided with pipe threading in order to be able to screw the new socket onto a pipe in the usual manner.

Because of the annular arrangement of the connectors according to the invention, a significant shortening of the socket is achieved; however, the use of standardized parts is not lost as a consequence. It is proposed in the new socket according to the invention to apply threading of the type found in previous sockets on the periphery of the socket. A particularly advantageous design incorporates threading not only on the outer periphery of the socket, but also second threading on the protective collar of the socket.

It is proposed according to the invention to arrange both threads on the same socket part—the housing—so that the parts can be manufactured out of plastic in an injection molding process. This design results in a simple configuration of the injection molding die used to manufacture the parts.

Since the invention seeks simple installation, it is proposed to provide a cover for all electrical connectors which would otherwise be readily accessible from the socket exterior, thus presenting a shock hazard. Ideally, this cover encloses all voltage-conducting parts and is simple to mount, but can only be removed with a tool, thus satisfying safety regulations. Although a custom tool could be provide to remove the protective cover, a cover which requires the use of a screwdriver or other such device would comply with this safety requirement.

In order to permit universal assembly, it is recommended to also provide additional fastening possibilities in the baseplate, for example, holes, which permit fastening to a wall by means of screws.

The use of screwless clamps and snap connections between the housing, baseplate and cover simplifies the new socket construction.

### BRIEF DESCRIPTION OF THE DRAWINGS

The drawings described below are to be viewed as an illustrative example, in order to better understand the idea of the invention. The examples are in no way to be interpreted as restrictive, since additional features of the invention and hints can be deduced from the drawings.

FIGS. 1 to 3 show, as an example, a socket system adapted to replace old-fashioned, threaded Edison sockets.

FIG. 1 shows a side view of the socket with the protective cover mounted,

FIG. 2 shows a section through the socket of FIG. 1; and

FIG. 3 shows a top view with the protective cover removed.

FIGS. 4 to 8 show an example of a socket according to the invention adapted for use with a safety-type lamp base and socket system roughly corresponding to U.S. Pat. No. 6,113,416.

FIG. 5 represents a section through the socket of FIG. 4; and

FIG. 6 shows a top view of this socket with the protective cover removed.

FIGS. 7 and 7a show a lamp base that fits the socket of FIGS. 4 and 5 in a base view and elevation.

FIG. 8 is a view of the socket of FIG. 4 with the protective cover mounted.

### DESCRIPTION OF THE PREFERRED EMBODIMENTS

The following details are apparent, in particular, from the figures.

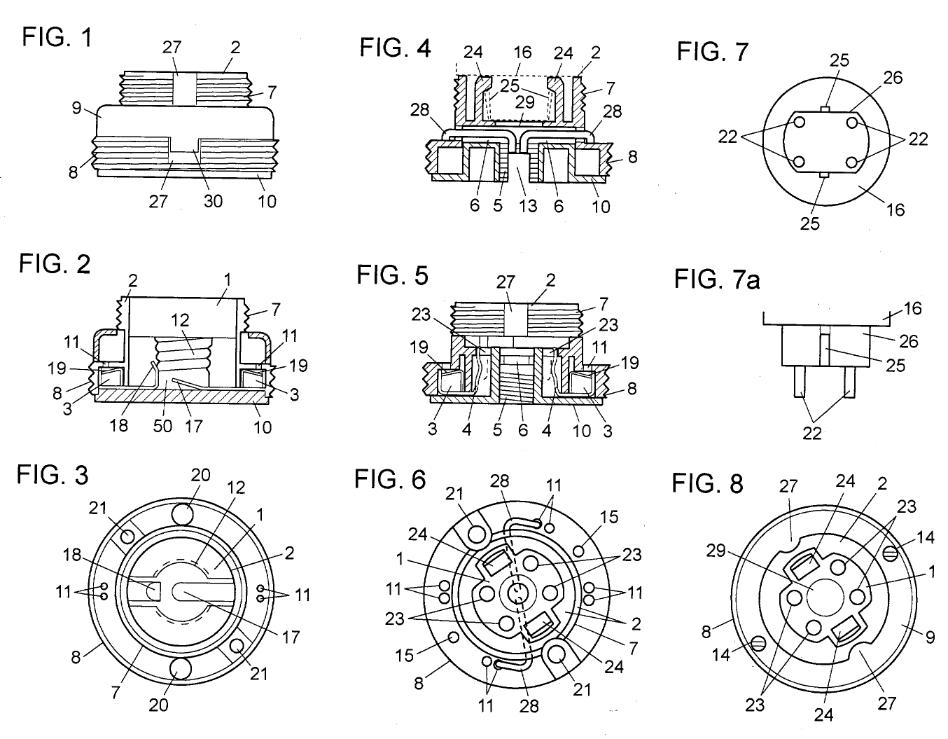

The main advantages of the idea of the invention are clearly apparent in FIGS. 1 and 2. The design height of the socket is less than half that of the previously common sockets, in which the connection contacts are arranged axially behind the contact. In the present invention, the connection contacts are arranged in annular fashion, which results in a shorter, low-profile lamp socket.

Moreover, the possibility of providing external threading (8) both on the protective collar (2) and on the outer periphery of the housing, makes this new socket compatible with nearly all sockets now in use. For example, the thread (7) on protective collar (2) can correspond to the internationally standardized dimensions of an Edison socket E14 and the external thread (8) can correspond to the dimensions of the also Worldwide standardized Edison thread E27. Lamps with a socket according to the invention could be used compatibly both with the fittings for the E14 and for the E27 system.

The section in FIG. 2 through this socket shows the simple design with a lamp holder (50) comprising a central screw thread (12) for lamps with an E14 base. The bottom contact (17) is designed as a simple stamped part and is configured as a screwless connector in conjunction with a contact spring (19). The situation is the same with the side contact (18), which, when equipped with contact spring (19), also represents a screwless connector. The power lines (13; see FIG. 4) can be inserted through holes (11; see FIG. 3), in which the adjacent hole (11) can serve for pushing the contact springs (19) back with a pin, in order to reloosen the wire connection.

The centrally arranged contact system to accommodate the lamp base carries a thread (7) on a protective collar (2), in order to be able to attach fittings, like lampshades, etc. Such fittings are available everywhere on the world market and are standardized, and the socket shown as an example is compatible with fittings for E14 sockets.

An external thread (8) is additionally provided on the largest diameter or outer periphery of the socket, which corresponds to the standards for Edison thread E27. Because of this, the socket is also compatible for all fittings that are on the market for the E27 sockets.

The advantage for the lamp manufacturer is obvious. With a single socket with extremely low design height, all the fittings for the previous E14 and E27 sockets can be used.

Assembly of the new sockets is extremely simple, since it consists, in principle, of only three plastic components, namely, the housing (1), the baseplate (10) and a protective cover (9), which protects the connected conductors (28) stripped of insulation on the end from contact, as shown in FIG. 6.

The power lines can be introduced axially into the socket, for example, through holes (20), in which holes (21) for fastening of the socket, for example, to a wall, do not protrude above the outer thread (8). Both the fastening holes (21) and the holes (20) for the power lines are enclosed after installation by protective cover (9).

The contact-shock-proof socket shown in FIGS. 4 to 8 is another schematic example to explain the idea of the invention. The sectional drawing of FIG. 4 shows how a lamp with a contact-shock-proof lamp base (16) can be used. For better understanding, FIG. 7 and FIG. 7a show a base view and elevation of such a lamp base (16) as example. This case involves a pin base with four base pins (22), which are held in a base projection (26). Base pins (22) are adapted to mate with holes (23) on a lamp holder (51) as shown in FIG. 8. Locking profiles (25) on the base projection secure the lamp after insertion in cooperation with spring snaps (24), as shown in FIG. 4. The lamp base (16) with its locking profile (25) is shown with dashed lines in FIG. 4. The lamp base (16) lies on the protective collar (2) after insertion of the lamp. The often observed penetration of dust or even insects in the previous sockets is, therefore, reliably avoided.

FIG. 5 shows a section through the contact system. The spring contacts (4) lie against the base pins (22) after insertion of the lamp, which pass through holes (23). The voltage-conducting spring contacts (4) lie behind holes (23) according to regulations and are contact-voltage-proof even during a lamp change.

In this example, the connectors (3) are shown as screwless clamps, in which the contact springs (19) also reliably clamp the blank ends of the insulated conductors (28) that are pushed through holes (11). FIG. 4 schematically depicts how the power line (13) with the insulated conductors (28) is inserted centrally into the baseplate (10), in which the central introduction in this example is configured as a pipe thread (5), which permits installation of the socket on a pipe end of corresponding diameter, as is common worldwide in the lighting industry.

In order to facilitate installation, an installation opening (29), accessible from the exterior, can be provided, which facilitates insertion of the insulated conductors (28) into channels (6).

After assembly is completed, the protective cover (9) is mounted on the socket according to FIG. 6 and fastened, for example, with two cover screws (14) through corresponding threaded mounting holes (15) provided on housing (1; see, FIG. 5). It goes without saying that a snap connection (30), as shown in FIG. 1, which can only be loosened with a tool (e.g., a screw driver), is also possible in this case, in order to make assembly of the protective cover (9) even simpler. The same also applies to assembly of the baseplate (10) to housing (1). The recesses (27) serve, if necessary, for positioning of the elastic protective cover (9), which can also have corresponding projections (30), as shown in the embodiment of FIG. 1.

The two sockets according to the invention depicted schematically as an example cannot exhaustively describe the idea according to the invention. Deviating from these examples, all parts can be configured in a different design. This applies to the contacts and to the locking system and connectors. The depicted examples exclusively serve solely for better understanding of the invention.

What is claimed is:

1. A low-profile lamp comprising:
a housing;
a protective collar on said housing, said collar adapted to retain the base portion of a lamp;
a contact system centrally arranged in said housing for supplying electrical power to said lamp base portion, at least a portion of said contact system disposed within said protective collar;
at least two connectors for connecting said contact system to a source of electrical power supply, said connectors arranged in annular fashion around the contact system, and at least a portion of both said connectors lying outside of the protective collar.

2. The lamp socket according to claim 1, wherein said socket is adapted for a compact fluorescent lamp having an integrated ballast

3. The lamp socket according to claim 1, wherein said socket is adapted for an incandescent lamp.

4. The lamp socket according to claim 1, wherein said socket is adapted for a lamp having a contact-voltage-proof mounting system.

5. The lamp socket according to claim 1, wherein said socket is adapted so that power lines can be introduced axially.

6. The lamp socket according to claim 1, further including a baseplate for sealing the housing, said baseplate including a central opening for introduction of a power line, and channels for connecting said power line to said connectors.

7. The lamp socket according to claim l, wherein the socket has threading on the socket outer periphery.

8. The lamp socket according to claim 1, wherein the socket has threading on the protective collar.

9. The lamp socket according to claim 1 wherein said protective collar is integral with said housing.

10. The lamp socket according to claim 1 further including a cover enclosing voltage-conducting portions of said socket, said cover adapted to be removed only by use of a tools.

11. The lamp socket according to claim 1, further including mounting holes for attaching said socket a wall surfaces on the baseplate.

9. A lamp socket comprising:
a) a housing;
b) a baseplate having a holder for mounting a lamp;
c) a protective collar surrounding said housing;
d) a contact system disposed centrally in said housing, said contact system having at least two clamps for connection to a source of electrical power, and wherein said clamps are arranged in annular fashion around said contact system and outside of said protective collar.

10. Lamp socket according to claim 9 wherein the socket has threading on its outer periphery.

11. Lamp socket according to claim 9 wherein the socket has threading on said protective collar.

12. Lamp socket according to claim 9 wherein power lines can be introduced axially.

13. Lamp socket according to claim 9 wherein a baseplate for sealing of the housing is present with a central entry having pipe threading for the insertion of power lines, and channels permit connection of the power lines to the connection clamps.

14. Lamp socket according to claim 9 wherein the protective collar is part of the housing and threading is arranged on the protective collar, and threading is also arranged on the outer periphery of said housing.

15. Lamp socket according to claim 9 wherein the connection clamps have a cover.

16. Lamp socket according to claim 15 wherein the cover can be removed only with tools.

17. Lamp socket according to claim 9 wherein means to attach the socket to flat surfaces are present on the baseplate.
